(19) United States
(12) Patent Application Publication
(10) Pub. No.: US 2026/0152401 A1
(43) Pub. Date: Jun. 4, 2026

(54) AMPHIPHILIC GRAPHENE OXIDE TEMPERATURE-RESISTANT FOAM STABILIZER FOR MAINTAINING WIDE PH RANGE AND PREPARATION METHOD THEREOF

(71) Applicant: Southwest Petroleum University

(72) Inventors: Ming ZHOU, Chengdu (CN); Jun LI, Chengdu (CN); Xiao GUO, Chengdu (CN); Yi LI, Chengdu (CN); Yuxiang LIU, Chengdu (CN); Linkai LI, Chengdu (CN); Zhihui MENG, Chengdu (CN); Yunyao WEI, Chengdu (CN); Jianhong ZHOU, Chengdu (CN); Ronghua YUE, Chengdu (CN); Zheng WU, Chengdu (CN); Jing ZHONG, Chengdu (CN); Chenyiting LI, Chengdu (CN); Zhou HUANG, Chengdu (CN); Yuchen JIAO, Chengdu (CN)

(73) Assignee: Southwest Petroleum University, (omitted)

(21) Appl. No.: 19/456,267

(22) Filed: Jan. 22, 2026

(30) Foreign Application Priority Data
Feb. 8, 2025 (CN) 202510138638.X

(51) Int. Cl. C01B 32/198; C01B 32/194

(52) U.S. Cl. CPC C01B 32/198; C01B 32/194; C01B 2204/24

(57) ABSTRACT

Disclosed is an amphiphilic graphene oxide (GO) temperature-resistant foam stabilizer for maintaining a wide pH range and a preparation method thereof. The amphiphilic GO is produced by dispersing GO in an ice-water bath, then sequentially adding a graphene oxide dispersion liquid, solid paraffin, emulsifier, and intercalation agent using a template method for emulsification and solidification. After washing and filtration, GO-coated paraffin microspheres are obtained. The microspheres are treated with hydrolyzed silane coupling agent, and further reacted with an amino modifier. GO-coated paraffin microspheres are dissolved completely in chloroform, followed by multiple centrifugation washes and freeze-drying to yield the foam stabilizer. The foam stabilizer has improved foam stability under high-temperature conditions across a wide pH range. It also possesses favorable interfacial activity and demonstrates a synergistic foaming effect with foaming agents. Therefore, it holds promising application prospects in fracturing and chemical flooding operations for high-temperature acidic oil and gas reservoirs.

### TECHNICAL FIELD

The present disclosure pertains to the field of oil and gas field development engineering technology, and particularly relates to an amphiphilic graphene oxide temperature-resistant foam stabilizer for maintaining a wide pH range and a preparation method thereof.

### BACKGROUND

With the rapid development of China's economy, the demand for energy and resources is increasing day by day. Particularly in the field of oil exploitation, enhancing crude oil recovery has become the focus of the industry. Chemical flooding and fracturing, as effective technologies for enhancing oil recovery, have been widely used. Nevertheless, when put into practical application, conventional foam exhibits the problem of insufficient foam stability, which limits the effectiveness and hinders the popularization of foam flooding technology as well as foam fracturing technology.

Due to the thermodynamic and kinetic instability inherent to foam, it is more prone to rupture under high-temperature and high-salinity conditions. Therefore, foam stabilizers play a crucial role in foam flooding technology. The foam stabilizers enhance foam stability, allowing it to remain stable for a long time within the complex underground environment, thereby enabling it to better perform its oil displacement function. Foam stabilizers are typically classified into three types: polymers, viscoelastic surfactants, and nanoparticles. Foam stabilizers mainly play the role of stabilizing foam by increasing the viscosity of foam and reducing the fluidity of foam. They are typically composed of high molecular polymers and can be subdivided into natural polymer foam stabilizers (such as cellulose, pectin, acacia gum, chitosan, guar gum and its derivatives), and artificial polymer foam stabilizers (such as polyvinyl alcohol (PVA), polyacrylamide (PAM), polyethylene oxide (PEO), polystyrene sulfonate, and polyvinylpyrrolidone (PVP)). This type of foam stabilizer is prone to decomposition at high temperatures, and the residual organic matter can impair the performance of foam fracturing fluid. Viscoelastic surfactant foam stabilizers can form a thick liquid film structure at the interface and suppress spatial density fluctuations at the air-water interface through intermolecular interactions, thereby providing a good stabilizing effect. Typically, such foam stabilizers exhibit synergistic effects with foaming agents, but their effectiveness is limited under high-temperature and high-salinity conditions. Solid particle foam stabilizers exhibit unique advantages in high-temperature and high-salinity environments, largely due to the low temperature sensitivity of solid particles. The particles are irreversibly and spontaneously adsorbed at the gas-liquid interface, where they balance interfacial tension to form a solid-liquid-gas three-phase interfacial film. This film prevents gas-liquid phase transfer and hinders drainage between the gas and liquid phases. Such stabilizers primarily include nano-silica, nano-titanium dioxide, nano-calcium carbonate, nano-montmorillonite, and graphene oxide. However, they are prone to agglomeration and sedimentation in aqueous solutions, making it difficult for them to adsorb at the gas-liquid interface, which consequently diminishes the foaming effect. As a consequence, modification of the nano-solid particle foam stabilizers is necessary. The modified particles demonstrate better dispersibility in water, possess moderate wettability, and can be stably adsorbed at the gas-liquid interface, thereby effectively improving foam stability.

In recent years, graphene oxide (GO), a two-dimensional nanomaterial, has been recognized for its high specific surface area, good mechanical strength, and excellent chemical stability. Researchers have found that GO particles possess significant potential for stabilizing foam. Owing to the oxygen-containing functional groups on their surface, GO particles can interact with gas molecules within the foam, thereby enhancing foam stability and making GO an ideal candidate material for foam stabilizers.

As early as 1913, Hoffmann proposed the foam-stabilizing effect of nano-solid particles. In recent years, numerous scholars have begun to focus on research concerning foam stabilization by nanoparticles. The Chinese patent application CN116148251A discloses a method for testing the foam stabilization performance of nano-CaCO₃/SiO₂ core-shell particles. In the present disclosure, nano-CaCO₃/SiO₂ core-shell particles are first synthesized and then modified. The resulting hyperbranched nano-particles possess cationic characteristics, exhibit a certain affinity for anionic foaming agents, and can be firmly adsorbed onto the surface of foam liquid films. On the other hand, the hyperbranched molecules contain a large number of hydrophilic groups, and the cavities within their branched units can encapsulate bound water molecules, control the diffusion of water molecules, and thereby effectively stabilize the foam fluid. However, the preparation process is complex. Moreover, CaCO₃ will dissolve under acidic conditions to generate corresponding calcium salts, water, and carbon dioxide gas, which cannot be applied to acidic oil and gas reservoirs, as well as in acidified oil and gas reservoirs. The Chinese patent application CN108410441B discloses a reinforced foam system based on synergistic stabilization of graphite oxide particles. Cetyltrimethylammonium bromide is used as a foaming agent, and the foam stabilizer consists of graphite oxide particles. This system exhibits good stability and a simple preparation process, but it suffers from high concentration requirements, high cost, and limited effectiveness across a wide pH range. Additionally, the foaming agent is a cationic surfactant, and the adsorption loss on the negative rock surface is too large, which affects the foam regeneration effect. The Chinese patent application CN201910517966.5 discloses a long-lasting foam with a low dosage of foam stabilizer and its preparation method. Compared to conventional foam, the half-life of the long-lasting foam prepared by this method increased by 550%. The particle foam stabilizer involved in this foam system is graphene oxide and/or aminated graphene, and an air-water interface synergist is also included, resulting in a complex composition. Moreover, while graphene oxide and/or aminated graphene are relatively stable in alkaline environments, their stability decreases significantly under acidic conditions, thus preventing their application in acidic formation environments. Similarly, the Chinese patent application CN116143823A discloses an amphiphilic nano-graphite high-temperature foam stabilizer, its preparation method, and a temperature-resistant three-phase foam system. Although nano-graphite can, to some extent, inhibit foam drainage, the thickness of its layered structure leads to relatively large particle sizes. This results in great gravitational differentiation at the foam liquid film interface, causing a steady decline in foam stability.

In view of the foregoing, a key technology for enhancing foam performance lies in effectively utilizing the unique physical and chemical properties of nanomaterials to improve foam stability. For example, GO particles can be modified via physical or chemical methods to further optimize their foam-stabilizing performance, make them keep temperature resistance and maintain a wide pH range, be environmentally friendly, and better adapt to complex formation environments. This is an urgent problem for technicians to address in this field.

### SUMMARY

In order to solve the above technical problems, the present disclosure provides an amphiphilic graphene oxide temperature-resistant foam stabilizer for maintaining a wide pH range and a preparation method thereof. The GO particle type foam stabilizer can maintain amphiphilicity across a wide pH range (3-12). By adsorbing onto the foam liquid film and forming a solid-liquid-gas three-phase foam, the foam film strength is improved, the drainage speed of the liquid film and the disproportionation rate of the foam reduced, thereby improving foam stability. The nano-foam stabilizer has a low concentration, a low manufacturing price, and a simple preparation method. The GO used as the raw material in the present disclosure is stable and possesses a high specific surface area. However, its lamellae easily undergo aggregation due to van der Waals forces. This behavior is primarily attributed to the presence of numerous oxygen-containing functional groups, such as hydroxyl and carboxyl groups, on the GO surface, which makes GO highly hydrophilic. In aqueous environments, graphene oxide sheets attract each other due to hydrogen bonds formed by water molecules, promoting the occurrence of the aggregation phenomenon, that is, a poor dispersibility of GO. Consequently, modification is required to endow it with the foam-stabilizing properties.

A method for preparing an amphiphilic graphene oxide temperature-resistant foam stabilizer for maintaining a wide pH range includes the following steps:
step (1), adding 1-2 parts of graphene oxide into 1000-2000 parts of deionized water, and ultrasonically dispersing the mixture in an ice water bath for 1 h to yield a graphene oxide dispersion liquid;
step (2), weighing and heating 30-40 parts of solid paraffin to a liquid state. At 70° C., sequentially adding a liquid paraffin, an emulsifier OP-10, and an intercalation agent cetyltrimethylammonium bromide (a ratio of the three parts is 55:1:10) into the graphene oxide dispersion liquid obtained in step (1), and emulsifying the mixture with an emulsifier at 10,000 rad/min for 20 min. After the emulsification is completed, the mixture is placed in the ice water bath to solidify paraffin microspheres. At this point, graphene oxide sufficiently coats a surface of paraffin microspheres, yielding graphene oxide-coated paraffin microspheres by removing free graphene oxide, cetyltrimethylammonium bromide and OP-10 via filtration and washing;
step (3), adding 1 part of a 36.5% concentrated hydrochloric acid into 300 parts of an absolute ethanol, stirring uniformly, adding 1-3 parts of a silane coupling agent, and hydrolyzing for 15 min to yield a hydrolyzate of the silane coupling agent. Transferring the obtained hydrolyzate of the silane coupling agent and the graphene oxide-coated paraffin microspheres prepared in the step (2) into a three-necked flask and reacting for 48-72 h at 30° C. with a stirring speed of 300 rad/min, allowing hydroxyl groups on outer sides of the graphene oxide sheets coated on the surface of the paraffin microspheres to couple with silanol groups of the hydrolyzed silane coupling agent, yielding a silane coupling agent-modified graphene oxide-coated paraffin microspheres dispersion liquid, referred to as an intermediate 1 dispersion liquid;
step (4), adding 3-4 parts of an amino modifier into the intermediate 1 dispersion liquid obtained in the step (3), performing a ring opening reaction between primary amine groups of the amino modifier and epoxy groups on the graphene oxide modified by the silane coupling agent, after reacting for 3-5 h, cooling the mixture to a normal temperature, and then suction filtering, and yielding amphiphilic graphene oxide-coated paraffin microspheres; and
step (5), fully dissolving the amphiphilic graphene oxide-coated paraffin microspheres obtained in the step (4) in 100 parts of a chloroform, centrifugally washed with 100 mL of ethanol solution for 6 times, and freeze-drying for 48 h, and yielding the amphiphilic graphene oxide temperature-resistant foam stabilizer.

The above silane coupling agent is KH-560, and its structural formula is:

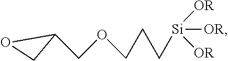

where R is a methyl.

The above amino modifier is diethylenetriamine, and its structural formula is

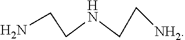

A hydrolysis reaction principle of the above silane coupling agent KH-560 is as follows:

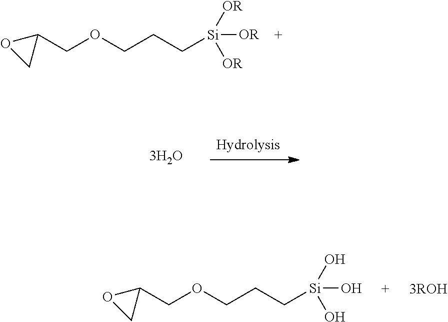

the hydroxyl groups on the graphene oxide are reacted with the silanol groups of the hydrolyzate of silane coupling agent KH-560 to obtain the intermediate 1, and its

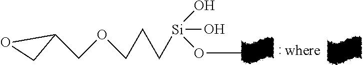

in the above structural formula is a main body of a graphene oxide structure.

The epoxy groups in intermediate 1 are reacted with primary amines of the amino modifier diethylenetriamine (DETA) to obtain a target product, an amphiphilic graphene oxide high-temperature resistant foam stabilizer, and its structural formula is:

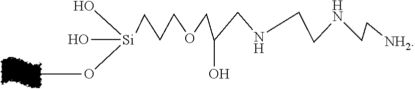 [SMILES: CO[Si](O)(O)CCCOCC(O)CNCCNCCN]

The advantages of the present disclosure are as follows:
(1) The functions of the amphiphilic graphene oxide high-temperature resistant foam stabilizer prepared by the present disclosure are to increase the strength of the foam liquid film, prevent bubble coalescence, and prolong liquid film drainage time. These effects collectively delay the bubble disproportionation rate, significantly enhance the foam stability, and maintain good foam stabilization performance under high-temperature conditions ranging from 100° C. to 160° C.
(2) The amphiphilic graphene oxide high-temperature resistant foam stabilizer prepared by the present disclosure possesses both a carboxyl group (—COOH) and an amine group (—NH₂), which exhibits amphiphilicity and acid-alkali resistance, and is capable of maintaining an effective foam stabilizing performance across a wide pH range (3-12).
(3) Conventional graphene oxide exhibits weak hydrophilic ability and poor dispersion ability in water, which leads to easy agglomeration of the foam stabilizer. In contrast, the amphiphilic graphene oxide high-temperature resistant foam stabilizer prepared by the present disclosure avoids such agglomeration of foam stabilizer, improves the dispersibility of the stabilizer in water, and enhances the quality of the foam.
(4) The template method employed in the present disclosure to prevent the paraffin-coated surface of the graphene oxide from undergoing chemical reactions, while the surfaces not coated with paraffin participate in the coupling and ring opening reactions. This approach effectively achieves amphiphilicity to the graphene oxide and enhances the surface interfacial properties of the amphiphilic graphene oxide high-temperature resistant foam stabilizer.
(5) The amphiphilic graphene oxide high-temperature resistant foam stabilizer prepared by the present disclosure exhibits favorable surface and interface activity. It enhances the strength of the foam liquid film, prolongs the liquid drainage time, improves the foam stability, and demonstrates a synergistic foaming effect with foaming agents.

### DETAILED DESCRIPTION OF THE EMBODIMENTS

The following is a detailed description of the present disclosure in conjunction with specific examples to enable those skilled in the art to better understand the present disclosure.

The parts in the specific examples are parts by mass.

### Examples 1-9

The nine groups of experiments in Examples 1-9 correspond to the amphiphilic graphene oxide foam stabilizers prepared by varying the amounts of solid paraffin, GO, deionized water, coupling agent KH560, amino modifier DETA, the coupling time and ring opening reaction time, while keeping all other experimental parameters and procedures constant. The specific variations in these parameters are provided in Table 1.

TABLE 1
Added amounts of main raw materials and reaction
times corresponding to Examples 1-9

| | | | | | | | Ring |
|---|---|---|---|---|---|---|---|
| | | GO Dispersion liquid | | Coupling | Amino | | opening |
| | Solid | GO | Deionized | agent | modifier | Coupling | reaction |
| | paraffin | amount | water | KH550 | DETA | time | time |
| Example | (part) | (part) | (part) | (part) | (part) | (h) | (h) |
| 1 | 30 | 1.0 | 2000 | 1 | 3.0 | 48 | 3 |
| 2 | 30 | 1.0 | 2000 | 2 | 3.0 | 48 | 3 |
| 3 | 30 | 1.0 | 2000 | 3 | 3.0 | 48 | 3 |
| 4 | 35 | 1.5 | 1500 | 1 | 3.5 | 72 | 4 |
| 5 | 35 | 1.5 | 1500 | 2 | 3.5 | 72 | 4 |
| 6 | 35 | 1.5 | 1500 | 3 | 3.5 | 72 | 4 |
| 7 | 40 | 2.0 | 1000 | 1 | 4.0 | 60 | 5 |
| 8 | 40 | 2.0 | 1000 | 2 | 4.0 | 60 | 5 |
| 9 | 40 | 2.0 | 1000 | 3 | 4.0 | 60 | 5 |

Effect of amphiphilic graphene oxide foam stabilizers on foam stability and foaming properties:

2 parts of the amphiphilic graphene oxide foam stabilizer prepared in Examples 1-9 are mixed with 1334 parts of water, and the mixture is ultrasonically dispersed for 25 min to obtain the amphiphilic graphene oxide foam stabilizer dispersion liquid; 8 parts of the amphoteric surfactant are added to the amphiphilic graphene oxide foam stabilizer dispersion liquid to obtain a foaming liquid. 200 mL of the foaming liquid is added to a high-temperature and high-pressure foaming machine, after foaming liquid stops in the foaming machine at a constant temperature of 140° C. for 15 min, the foam is performed at a constant stirring rate of 4000 rad/min, and a stirring time of 60 s to obtain the foam volume and half-life of the foaming liquids of Examples 1 to 9, respectively, as shown in Table 2. Specifically, the amphiphilic surfactant is one of cocamidopropyl betaine, erucic acid amidopropyl betaine and oleic acid amidopropyl betaine, and the cocamidopropyl betaine is the preferred option among these.

Comparative Example 1, 2 parts of unmodified graphene oxide are mixed with 1334 parts of liquid preparation water, and the mixture is ultrasonically dispersed for 25 min to obtain a graphene oxide dispersion liquid. A further 8 parts of the amphoteric surfactant are added to the graphene oxide dispersion liquid to obtain a foaming liquid. 200 mL of foaming liquid is added into a high-temperature and high-pressure foaming machine, after foaming liquid stops in the foaming machine at a constant temperature of 140° C. for 15 min, the foam is performed at a constant stirring rate of 4000 rad/min, and a stirring time of 60 s to obtain the foam volume and half-life of the foaming liquid of Comparative Example 1, respectively. The results are shown in Table 2.

Comparative Example 2. Without the addition of graphene oxide and amphiphilic graphene oxide, 8 parts of amphoteric surfactant are directly mixed with 1334 parts of liquid preparation water to obtain a foaming liquid. 200 mL of foaming liquid is added into a high-temperature and high-pressure foaming machine, after foaming liquid stops in the foaming machine at a constant temperature of 140° C. for 15 min, the foam is performed by a constant stirring rate of 4000 rad/min, and a stirring time of 60 s to obtain the foam volume and half-life of the foaming liquid of Comparative Example 2, respectively. The results are also shown in Table 2.

TABLE 2
Foam volume and half-life for examples and comparative examples

| | Foam stabilizer | | | |
|---|---|---|---|---|
| | | Stabilizer | Foam half- | Foam |
| | | dosage | life | volume |
| Experiment Number | Stabilizer type | (wt %) | (min) | (mL) |
| Comparative | Unmodified | 0.015 | 222 | 480 |
| Example 1 | GO | | | |
| Comparative | None | 0 | 208 | 485 |
| Example 2 | | | | |
| Example 1 | Amphiphilic | 0.015 | 518 | 610 |
| | GO | | | |
| Example 2 | Amphiphilic | 0.015 | 546 | 615 |
| | GO | | | |
| Example 3 | Amphiphilic | 0.015 | 574 | 600 |
| | GO | | | |
| Example 4 | Amphiphilic | 0.015 | 600 | 620 |
| | GO | | | |
| Example 5 | Amphiphilic | 0.015 | 614 | 630 |
| | GO | | | |
| Example 6 | Amphiphilic | 0.015 | 506 | 635 |
| | GO | | | |
| Example 7 | Amphiphilic | 0.015 | 485 | 615 |
| | GO | | | |
| Example 8 | Amphiphilic | 0.015 | 515 | 625 |
| | GO | | | |
| Example 9 | Amphiphilic | 0.015 | 505 | 620 |
| | GO | | | |

At 140° C., Comparative Example 1 with unmodified graphene oxide as the foam stabilizer and Comparative Example 2 without the foam stabilizer exhibit foam half-lives of 222 min and 208 min, and foaming volumes of 480 mL and 485 mL, respectively. This demonstrates that unmodified graphene oxide does not significantly improve foam stability, and its foaming effect is very limited. In contrast, when the amphiphilic graphene oxide foam stabilizer of the present disclosure is employed, the foam half-life increases by 1 to 2 times, and foam stability is greatly improved and the foaming volume rises by approximately 50%, then it exhibits a significant foaming effect. Specifically, the foam stabilizer from Example 5 achieved a half-life of 614 min and a foaming volume of 630 mL. These results indicate that foam stability is greatly improved, and the foaming volume is significantly increased, too.

Foam stability and foaming properties under different pH conditions:

Dilute solutions of hydrochloric acid or sodium hydroxide are employed to adjust pH of the foaming liquids prepared in Example 5, thereby preparing twelve groups of foaming liquids with the pH values of 2, 3, 4, 5, 6, 7, 8, 9, 10, 11, 12, and 13, as described in Table 3. The foaming properties of these liquids under different pH conditions are tested, and the experimental conditions and methods of the test are the same as those in Table 2

TABLE 3
Foam stability and foaming properties under different pH conditions

| | Foam stabilizer | | | | |
|---|---|---|---|---|---|
| | | Stabilizer | | | |
| Experiment | | dosage | | Foam half-life | Foam volume |
| Number | Stabilizer type | (wt %) | pH | (min) | (mL) |
| Examples | Amphiphilic | 0.015 | 2 | 289 | 395 |
| 5-2 | GO | | | | |
| Examples | Amphiphilic | 0.015 | 3 | 503 | 510 |
| 5-3 | GO | | | | |
| Examples | Amphiphilic | 0.015 | 4 | 553 | 555 |
| 5-4 | GO | | | | |
| Examples | Amphiphilic | 0.015 | 5 | 585 | 590 |
| 5-5 | GO | | | | |
| Examples | Amphiphilic | 0.015 | 6 | 600 | 610 |
| 5-6 | GO | | | | |
| Examples | Amphiphilic | 0.015 | 7 | 614 | 630 |
| 5-7 | GO | | | | |
| Examples | Amphiphilic | 0.015 | 8 | 645 | 620 |
| 5-8 | GO | | | | |
| Examples | Amphiphilic | 0.015 | 9 | 647 | 610 |
| 5-9 | GO | | | | |
| Examples | Amphiphilic | 0.015 | 10 | 637 | 605 |
| 5-10 | GO | | | | |
| Examples | Amphiphilic | 0.015 | 11 | 516 | 575 |
| 5-11 | GO | | | | |
| Examples | Amphiphilic | 0.015 | 12 | 428 | 525 |
| 5-12 | GO | | | | |
| Examples | Amphiphilic | 0.015 | 13 | 324 | 415 |
| 5-13 | GO | | | | |

The foaming half-life and foaming volume of the foaming liquids prepared in Example 5 at different pH values are shown in Table 3. As can be seen, different pH values result in different foam half-lives and foaming volumes. The improvement of foam stability not only depends on the amphiphilicity provided by the pH-responsive characteristic groups (—COOH and —NH₂) and the surfactant on the modified graphene oxide structural unit but also benefits from the three-phase foam system composed of graphene oxide, amphoteric surfactant, and deionized water. Furthermore, the inherent high thermal stability of graphene oxide contributes to the high temperature resistance of the material prepared by the present disclosure. Meanwhile, such test has also not been performed in other patents in the same technical field.

The modified nano-foam stabilizer provided by the present disclosure has a good foam stabilizing effect on amphoteric surfactant-based foaming agents, and the foam stabilizer with the optimal foam stabilizing effect is Example 5. As a result, the graphene oxide temperature-resistant foam stabilizer for maintaining amphiphilicity across a wide pH range is a lamellar structure, and exhibits good foam properties across a wide pH range (3-12).

Any content not specifically described herein in this specification constitutes prior art known to those skilled in the art.

What is claimed is:

1. An amphiphilic graphene oxide temperature-resistant foam stabilizer for maintaining a wide pH range, produced by the following steps, wherein all raw materials are in parts by mass:
step (1), adding 1-2 parts of graphene oxide into 1000-2000 parts of deionized water, and ultrasonically dispersing the mixture in an ice water bath for 1 h to yield a graphene oxide dispersion liquid;
step (2), weighing and heating 30-40 parts of solid paraffin to a liquid state to 70° C., sequentially adding 55 parts of a liquid paraffin, 1 part of an emulsifier OP-10, and 10 parts of an intercalation agent cetyltrimethylammonium bromide into the graphene oxide dispersion liquid obtained in step (1), and emulsifying the mixture with an emulsifier at 10,000 rad/min for 20 min; after the emulsification is completed, placing the mixture in the ice water bath to solidify paraffin microspheres, wherein graphene oxide sufficiently coats a surface of paraffin microspheres, and obtaining graphene oxide-coated paraffin microspheres by removing free graphene oxide, cetyltrimethylammonium bromide and OP-10 via filtration and washing;
step (3), adding 1 part of 36.5% concentrated hydrochloric acid into 300 parts of an absolute ethanol, stirring uniformly, adding 1-3 parts of a silane coupling agent, and hydrolyzing for 15 min to yield a hydrolyzate of the silane coupling agent, transferring the yielded hydrolyzate of the silane coupling agent and the graphene oxide-coated paraffin microspheres prepared in the step (2) into a three-necked flask and reacting for 48-72 h at 30° C. with a stirring speed of 300 rad/min, thus allowing hydroxyl groups on outer sides of the graphene oxide sheets coated on the surface of the paraffin microspheres to couple with silanol groups of the hydrolyzed silane coupling agent, and yielding an intermediate 1 dispersion liquid;
step (4), adding 3-4 parts of a diethylenetriamine (DETA) into the intermediate 1 dispersion liquid obtained in the step (3) as an amino modifier, performing a ring opening reaction between primary amine groups of the amino modifier and epoxy groups on the graphene oxide modified by a silane coupling agent KH-560; after reacting for 3-5 h, cooling the mixture to a normal temperature, and then suction filtering, yielding amphiphilic graphene oxide-coated paraffin microspheres; wherein a structural formula of the silane coupling agent KH-560 is: 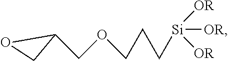
wherein R is a methyl, and a structural formula of KH-560 hydrolysate is 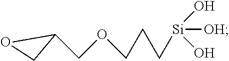 [SMILES: O[Si](O)(O)CCCOCC1CO1]
and
step (5), fully dissolving the amphiphilic graphene oxide-coated paraffin microspheres obtained in step (4) in 100 parts of a chloroform, centrifugally washing with 100 mL of ethanol solution for 6 times, and freeze-drying for 48 h, and yielding the amphiphilic graphene oxide temperature-resistant foam stabilizer as a final product.

2. The amphiphilic graphene oxide temperature-resistant foam stabilizer according to claim 1, wherein the structural formulae of intermediate 1 and the final product are 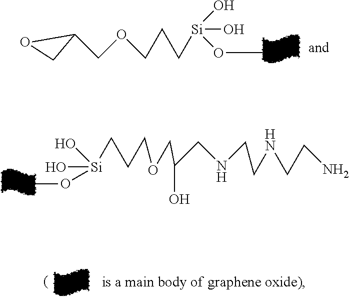
respectively.

3. The amphiphilic graphene oxide temperature-resistant foam stabilizer according to claim 1, wherein the amphiphilic graphene oxide temperature-resistant foam stabilizer is capable of maintaining the amphiphilicity under a high temperature ranging from 100° C. to 160° C. and a wide pH range of 3 to 12.
